(19) United States
(12) Patent Application Publication
(10) Pub. No.: US 2004/0071375 A1
(43) Pub. Date: Apr. 15, 2004

(54) Bearing

(76) Inventor: Paul Beaumont, Darton (GB)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/461,731

(22) Filed: Jun. 13, 2003

(30) Foreign Application Priority Data
Jun. 19, 2002 (GB) 0214207.3

(51) Int. Cl. F16C 19/00

(52) U.S. Cl. 384/470

(57) ABSTRACT

The invention relates to the provision of an improved bearing and to apparatus incorporating the same. The bearing is particularly for use in environments where the bearing is submerged in a fluid and is used in conjunction with a component which allows the flow of fluid therethrough. The bearing has an inner and outer race and a cage within which a series of ball bearings are provided. In accordance with the invention a channel is formed between the cage, inner and outer races through which fluid can pass. The provision of the flow, prevents clogging with debris and minimises damage due to corrosion or other chemical attack on the bearing.

### CROSS REFERENCE TO RELATED APPLICATIONS

This application claims priority to co-pending British Patent Application No. 0214207.3 entitled “Improved Bearing”, filed Jun. 19, 2002.

This invention relates to an improved rolling element bearing, and more particularly to an improved bearing for use in an hydraulic, aquatic or other fluid environments wherein the bearing is likely to be subjected to or come into contact with a fluid when both bearing and liquid are in motion.

Although the following description is predominantly concerned with the use of bearings in hot tub, water spa, pool cleaners, shower nozzles, and Jacuzzi™ applications, the reader will instantly appreciate that the invention has much wider application, and in particular the bearing of the invention may be considered for use in any apparatus in which the bearing is likely to come into contact with a fluid, and more probably a liquid in which debris (such as human created debris, e.g. hair, skin, clothing particles, and other particulate matter such as sand, dirt etc.) may be contained and which is required to flow through the bearing.

The most common usage for the types of bearing with which this application is predominantly concerned is in hot tub, water spa, pool cleaners, shower nozzles and Jacuzzi™-type baths in which are incorporated pumps and other liquid displacement apparatus which include one or more rotationally moving nozzles through which water flows, sometimes at high velocity to provide a massaging effect on the occupant of the bath. Typically the apparatus may be located in a cavity of the bath behind one of the walls thereof, and the nozzles be pivotally or otherwise rotationally mounted in the walls of the bath so that the water flowing therethrough is directed predominantly into the main bath cavity.

It is important to mention that the cavity in which the liquid displacement apparatus is housed is usually a wet region in that sometimes large quantities of liquid may also be present therein, and furthermore some of this liquid may be destined for delivery to the main bath cavity. Furthermore, the bearings in which the rotationally moving nozzles of the apparatus are mounted may be submerged in fluid, and this fluid may be in a state of constant motion, particularly if the apparatus functions by delivering liquid through the various nozzles provided thereon by means of recirculating the fluid from a reservoir in which the pumping, displacement, piping, and nozzle feeding apparatus may be submerged.

Pervasive problems associated with such apparatus, and in particular the bearings used to support rotationally moving apparatus which are partially or totally submerged in a moving liquid, are that said bearings are prone to degradation on account of possible chemical attack and also their efficacy may be compromised by the clogging effect of debris and other particulate matter which may be contained in the fluid. It is to be mentioned that clogging of bearings is a problem with all common types of bearing, e.g. caged bearings, full complement bearings, bush bearings etc.

This latter disadvantage is especially common where the bearing is used to support rotationally moving components within a flow of liquid wherein the liquid is required to flow through the bearing and around or to the outside of the component it supports.

In this instance, particulate matter can easily become lodged on the cage lugs behind the cage or between the cage and the ball bearings contained within the cage in the track area, and as soon as this occurs, the frictional resistance of the bearing increases dramatically, and in extreme cases the bearing is entirely prevented from rotating, ultimately resulting in the failure of the apparatus as a whole. As each of the lugs in any particular pair is slightly toed toward its respective partner at their tips to ensure that the axial motion of the ball bearings within the bearing is limited and the cage is retained within the bearing assembly. The lugs of each pair thereof may also be provided with spherical inner surfaces to prevent the ball bearings from escaping from the cage even in the absence of the inner and outer races in which the zeniths and nadirs of the ball bearings at any particular time are rotating. A further design flaw in conventional bearings is the number of ball bearings which have heretofore been considered necessary to ensure as free and as frictionless a motion as possible. In the bearings currently used in the type of apparatus described above, which may be only of the order of 4 cm in diameter, the inclusion of 12 steel ball bearings has a significant effect on both the weight and the frictional resistance of the bearing as a whole. Typically, to ensure the robustness of the cage and to ensure that it does not disintegrate during use, the interstices between the balls must be rigidified by the inclusion of additional plastics material to strengthen the cage as a whole. The result is again the prevention of flow of fluid through the bearing.

It is an object of this invention to provide a bearing for use in fluid, typically liquid, environments and particularly where the liquid is contaminated with debris or particulate matter which has reduced friction, weight and thus inertial characteristics and which is nevertheless much less prone to failure on account of debris clogging and chemical and other particulate degradation.

According to the invention in a first aspect there is provided a bearing comprising a cage and inner and outer races, said cage having a base from which extend a plurality of sets of retaining means, each set of retaining means separated to define a space in which a ball bearing is received, said inner race having a groove defined thereon along which the ball bearings roll, said outer race also having a groove along which said ball bearings are adapted to roll, and between which the ball bearings are retained, said cage retained in position with respect to the inner and outer races and characterised in that a channel is formed between the flange of the inner race, the base of the cage and the interior surface of the outer race said channel allowing the passage of fluid through the same

Most preferably, the lugs extend forwardly from the base annulus of the cage to define a space therebetween which receives a ball bearing in a manner which prevents circumferential movement of the ball bearings relative to the cage but does not restrict the axial movement of said ball bearings.

Most preferably the ball bearings are manufactured in a material having a density which is less than that of the fluid in which the bearing may be submerged. For example, in the instances where the bearing is to be used in apparatus which delivers water, it is preferable that the ball bearings are made in polypropylene which typically has a density of 0.9 g/cm³. Not only does this result in a significant reduction in weight and inertial resistance of the bearing (steel has a density of approx. 7-8 g/cm³), but in cases where the bearing is to be submerged in water, the lower density of the ball bearings causes them to “float” or at least become more buoyant in the surrounding fluid thus reducing the force required to move them. Indeed it is to be mentioned that any material having a density approximately the same as or similar to that of the fluid in which the bearing is commonly disposed will improve the operational characteristics of the bearing in that fluid.

Most preferably the inner and outer races and the cage which restricts the circumferential movement of the ball bearings are made in a plastics material such as polyester, or other materials selected to be compatible with chemicals or debris which may be present in the fluid, and additionally it is to be mentioned that the choice of material for one component of the bearing will depend on the materials chosen for the other components. Other suitable materials may be ABS, polyester or blends thereof.

Indeed, it is preferable that all the components of the bearing are made from thermoplastics materials which compounded to withstand chemical attack, in particular from sanitizing agents such as chlorine, bromine, and ozone which are commonly used in the types of applications hereinbefore discussed.

Most preferably, the inner race is provided with an annular skirt immediately in front of the flange and to the outside of the race, said skirt having an outer diameter which is less than the inner diameter of the base annulus of the cage. This permits the base annulus to rotatingly slip over the skirt with the minimum of frictional resistance.

Most preferably, the outer radial dimension of the base annulus of the cage is greater than the maximum radial dimension of the flange of the inner race which retains said cage in place, but is smaller than the diameter of the inner face of the outer race so as to define an annular gap between the base annulus of the cage and the rearmost lip on the inside of the outer race so that there is defined a passage for the flow of fluid through the bearing.

Of course, the outer radial dimension of the base annulus of the cage may be less than the corresponding radial dimension of the flange of the inner race, and such arrangement would not prevent the bearing from operating in a satisfactory manner. Indeed, with this arrangement, the annular gap between the outer edge of the base annulus and the rearmost lip on the inside of the outer race may be enlarged allowing for a greater fluid flow therethrough.

Most preferably there are five, six or seven ball bearings circumferentially equidistantly spaced in the grooves of the inner and outer race of the bearing after assembly, but in any event it is desirable that the minimum practical number of ball bearings is used.

The primary advantage of the bearing of the present invention is that there is at least one clear path defined for fluid to flow through the bearing. Preferably the retaining means are provided as lugs with the lugs in each set parallel as opposed to being curved towards one another in each pair as is the case in the bearings of the prior art. This prevents debris and other particulate matter from becoming trapped between the ball bearings and the lug tips.

The result is a bearing which is lightweight, has a comparatively low frictional resistance, and whose lifespan is significantly enhanced in normal operating conditions, in particular when partially or totally submerged in a liquid.

In a further aspect of the invention there is provided a bearing formed from an inner race, an outer race and a cage, said cage formed with retaining means to allow plurality of spaced ball bearings to be retained and moved along a circular path defined by the inner and outer races, said inner, outer races and cage rotatably movable with respect to each other about a common axis, said inner race defining an aperture through which a fluid can pass from a first face of the bearing to the second opposing face of said bearing, said first and second faces perpendicular to the axis of rotation, said fluid carried within a component positioned with respect to said inner race and wherein said bearing includes a channel defined between said outer race, cage and inner race through which fluid can pass between said first and second faces.

Typically the channel is annular and the fluid passes between the said first and second faces in the same direction as the fluid which flows through the said aperture.

In a further aspect of the invention there is provided a bearing comprising a cage surrounded by inner and outer races, said cage having a base annulus axially forward of which extend a plurality of pairs of lugs, each pair of lugs being separated by a distance marginally greater than the diameter of the ball bearing which is received between each pair of lugs, said inner race being generally cylindrical with a groove defined between axially spaced lips defined on the outer surface of said inner race in which the ball bearings are adapted to roll, said outer race being also generally cylindrical and having a groove defined on its inner cylindrical surface in which said ball bearings are adapted to roll, the configuration and dimensions of the components being such that when the bearing is assembled, the ball bearings are prevented from escaping from the bearing or moving axially therein by virtue of the grooves in the races, and the ball bearings are prevented from moving circumferentially relative to one another by means of the cage, said inner race being further provided with a flange extending radially outwardly from its rearmost edge such that the base annulus of the cage is prevented from escaping axially rearwardly of the bearing, characterised in that the radial dimensions of the flange of the inner race, the base annulus of the cage and the rearmost lip defined on the interior surface of the outer race are such that an appreciable uninterrupted annular gap prevails between the rearmost lip on the inner surface of the outer race and one or other of the outer edges of the base annulus and the inner race flange.

In a further aspect of the invention there is provided apparatus for dispensing a fluid from a first position to a second spaced position, said apparatus including at least one water nozzle through which the fluid passes, said water nozzle provided to rotate with respect to a bearing in which the same is positioned and wherein the bearing is formed as herein described.

A specific embodiment of the invention will now be described by way of example with reference to the accompanying drawings wherein:

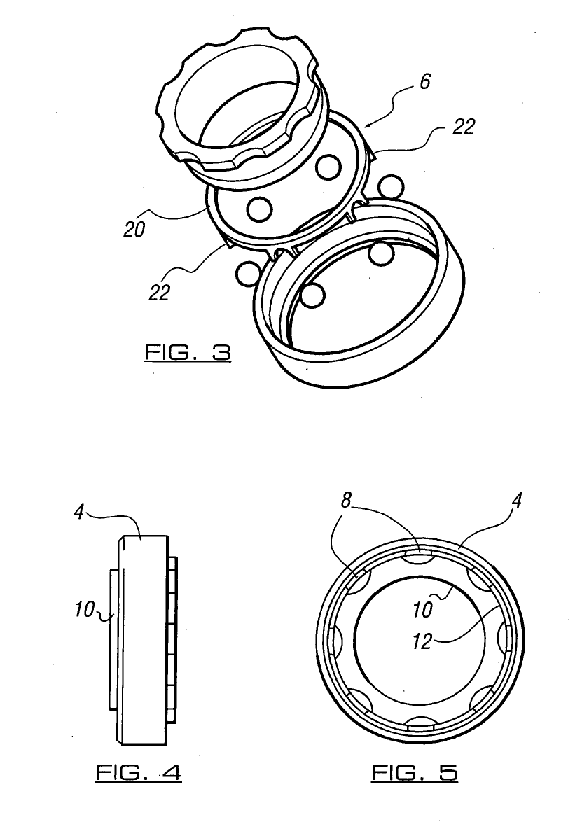

FIGS. 1, 2 and 3 show respectively exploded perspective views of a bearing according to the invention as seen from the front, side and rear of the bearing respectively;

FIGS. 4 and 5 show respectively a side elevation and a rear elevation of the assembled bearing according to the invention;

FIGS. 6, 7 and 8 show respectively a front elevation, a sectional view and an enlarged rear elevation of the assembled bearing of FIGS. 4 and 5; and

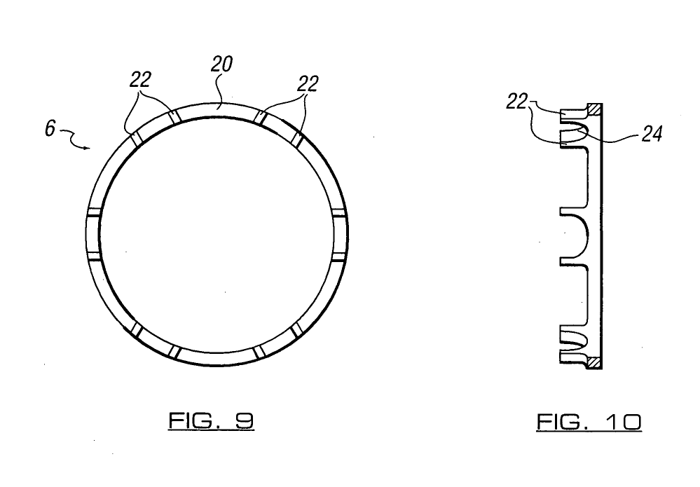

FIGS. 9 and 10 show respectively a front elevation, and a sectional view of the cage used in the bearing shown in the previous figures.

Referring firstly to FIGS. 1 to 3, there is shown a bearing 2 comprising an outer race 4, a cage 6 which is used to support a plurality of spherical ball bearings 8, and an inner race 10 through which a rotationally moving component, such as a water nozzle is adapted to pass and interferingly fit therewith. It is to be mentioned that the nozzle may be integrally moulded with the inner race, and thus nozzle and inner race may be a single component.

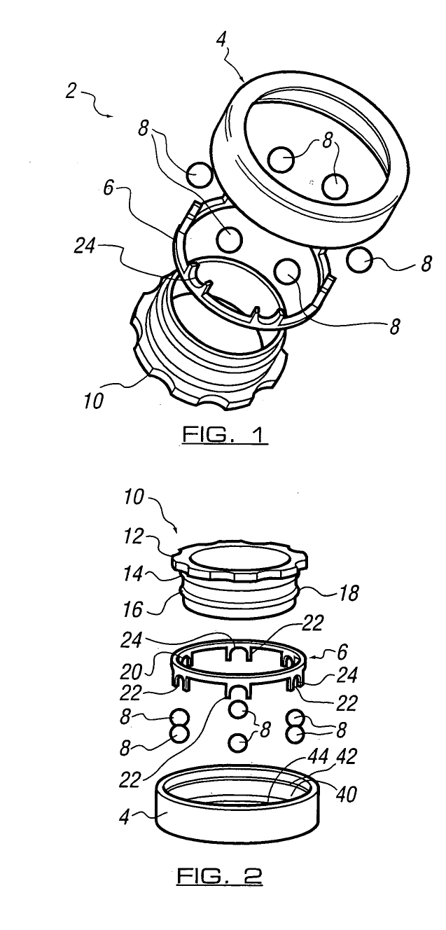

It can be seen more clearly in FIG. 2 that the inner race 10 is provided with a flange 12 which extends radially outwardly of the inner race, and beneath the flange 12 is provided a skirt 14 with a cylindrical surface which, on the one hand, defines a groove 16 with a lip 18 in which the ball bearings 8 are received and may rotationally travel in the assembled bearing, and on the other hand said skirt 14 provides a cylindrical surface over which the cage 6 can rotate during the operation of the bearing.

More particularly, the cage 6 consists of a base annulus 20 from which forwardly extend a series of pairs of lugs 22 which are spaced apart by a distance marginally greater than the diameter of the ball bearings 8 which they are adapted to receive therebetween, or more precisely said lugs 22 are spaced by a distance marginally greater than the maximum diameter of the cord plane of the spherical ball bearings 8 which they receive.

As will be seen from the figures, between each of the pairs of lugs 22 there is provided an arcuate surface 24 to improve the snugness of the fit of the ball bearings 8 between each lug set.

It is important to note that the lugs extend axially forward of the base annulus 20, and in a generally perpendicular direction thereto, and furthermore that the tips of the lugs are not “toed in” so as to clamp or otherwise encapsulate the ball bearings 8 therebetween. Indeed, were it not for the provision of the outer race 4, and in particular the groove 40 defined on the interior surface of said outer race and in which the spherical ball bearings are adapted to rotationally move in accordance with known bearing technology, said ball bearings 8 would escape freely from between the pairs of lugs 22 and be capable of movement in a generally axially direction within and possibly without the bearing. Moreover, it is the primary function of the lugs 22 to provide a restriction as to the motion of the ball bearings in only a circumferential direction such that the ball bearings cannot move relative to the cage once the bearing has been assembled.

It can also be seen from FIGS. 1 to 3 that the outer race 4 is provided on its interior cylindrical surface with a groove 40 which is defined between a rear lip 42 and a front lip 44 which together with the grove 16 provided on the outer cylindrical surface of the inner race I/O in the assembled bearing ensures that any axial motion of the ball bearings 8 is limited or eliminated, and that said ball bearings can move only rotationally within the space defined between the channels 16 and 40 in the assembled bearing.

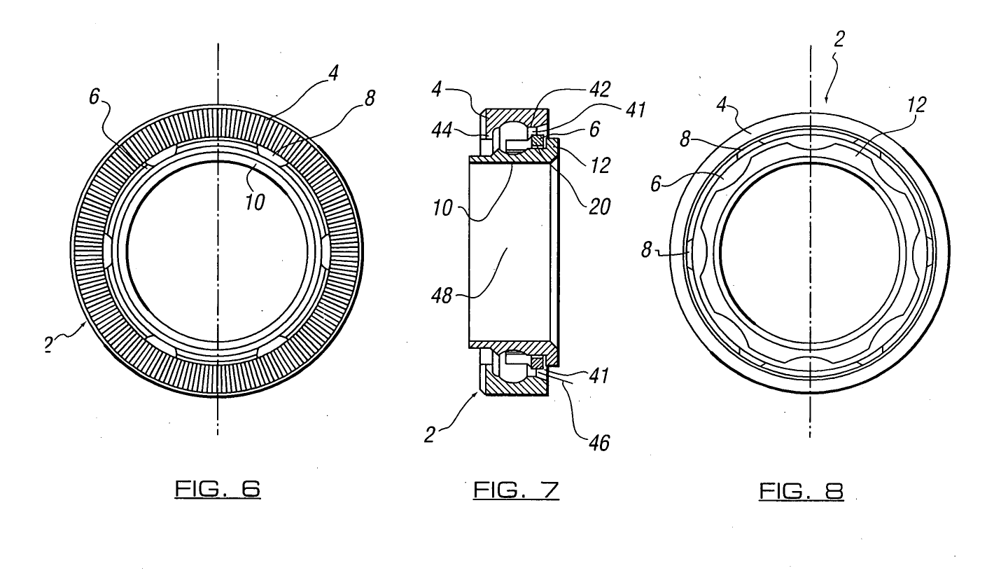

In FIG. 7, the relative dimensions of the various component parts of the bearing can easily be seen, and in accordance with this invention, it can be seen that there is an appreciable gap between the outermost surface of the base annulus 20 of the cage 6, and the edge of the rearmost lip 42 of the outer race 4. This gape defines the opening into the channel 41 which passes around the bearing and through which channel fluid can flow. It can also be seen from this figure that the maximum radial dimension of the base annulus 20 of the cage 6 is only marginally greater than the maximum radial dimension of the flange 12 of the inner race I/O, and these two factors in combination ensure that there is a clear and appreciable channel 41 for fluid flow generally indicated at 46 through which fluid the bearing 2 can flow, particularly in the case where the bearing is submerged in a consistent and continuous flow as identified at arrow 48. It is this appreciable gap and the resulting clear passageway 41 through the bearing which provides the beneficial effect, and which are fundamental to the advantages of the bearing as hereinbefore described. It is to be emphasised that the direction of the flow is important as the bearing is designed to withstand the axial force generated by virtue of the flow of fluid therethrough, and furthermore the bearing is designed to allow the flow of fluid through the annular gap in the direction shown in the figures with as little resistance as possible.

It is preferable that the various components which together form the bearing are made in thermoplastics materials, and in a most preferred embodiment, the inner and outer races, and the cage are preferably manufactured in a compounded polyester material, whereas the ball bearing are manufactured in a compounded polypropylene material, this particular construction being of advantage on account of the density of polypropylene being less than that of water which results in the ball bearings having the tendency to “float” or at least become more buoyant when the bearing as a whole is submerged in water.

It is also to be appreciated that the above represents only one specific combination of materials that is chosen to provide the bearing with the advantages described. The choice of materials depends on the circumstances and conditions in which the bearing is to be used.

1. A bearing comprising a cage and inner and outer races, said cage having a base from which extend a plurality of sets of retaining means, each set of retaining means separated to define a space in which a ball bearing is received, said inner race having a groove defined thereon along which the ball bearings roll, said outer race also having a groove along which said ball bearings are adapted to roll, and between which the ball bearings are retained, said cage retained in position with respect to the inner and outer races and characterised in that a channel is formed between the flange of the inner race, the base of the cage and the interior surface of the outer race said channel allowing the passage of fluid through the same.

2. A bearing according to claim 1 wherein the channel allows the passage of fluid therethrough in the same direction as fluid which passes through a fluid carrying means positioned in the aperture defined by the inner race.

3. A bearing according to claim 1 wherein the fluid carrying means is a water nozzle.

4. A bearing according to claim 3 wherein the inner race is formed as an integral part of the water nozzle.

5. A bearing according to claim 1 wherein the retaining means are lugs, two of which form a set and which extend forwardly from the base annulus of the cage to receive a ball bearing and limit circumferential movement of the ball bearing relative to the cage.

6. A bearing according to claim 1 wherein the ball bearings are manufactured of a material having a density which is less than that of the fluid in which the bearing is submerged.

7. A bearing according to claim 6 wherein the ball bearings are made of a material which has a density of 0.9 g/cm³.

8. A bearing according to claim 1 wherein the inner and outer races and the cage are made in a plastics material.

9. A bearing according to claim 8 wherein the inner and outer race and the cage are made from thermoplastics material.

10. A bearing according to claim 1 wherein the inner race is provided with an annular skirt in front of the flange and to the outside of the race, said skirt having an outer diameter which is less than the inner diameter of the base of the cage.

11. A bearing according to claim 10 wherein the base annulus can rotatingly slip over the annular skirt.

12. A bearing according to claim 1 wherein the outer radial dimension of the base of the cage is greater than the maximum radial dimension of the flange of the inner race which retains said cage in place.

13. A bearing according to claim 1 wherein an annular channel between the base annulus and the rearmost lip on the inside of the outer race is provided.

14. A bearing formed from an inner race, an outer race and a cage, said cage formed with retaining means to allow plurality of spaced ball bearings to be retained and moved along a circular path defined by the inner and outer races, said inner, outer races and cage rotatably movable with respect to each other about a common axis, said inner race defining an aperture through which a fluid can pass from a first face of the bearing to the second opposing face of said bearing, said first and second faces perpendicular to the axis of rotation, said fluid carried within a component positioned with respect to said inner race and wherein said bearing includes a channel defined between said outer race, cage and inner race through which fluid can pass between said first and second faces.

15. A bearing according to claim 14 wherein the channel is annular.

16. A bearing according to claim 14 wherein the fluid passes between the said first and second faces in the same direction as the fluid which flows through the said aperture.

17. A bearing comprising a cage surrounded by inner and outer races, said cage having a base annulus axially forward of which extend a plurality of pairs of lugs, each pair of lugs being separated by a distance marginally greater than the diameter of the ball bearing which is received between each pair of lugs, said inner race being generally cylindrical with a groove defined between axially spaced lips defined on the outer surface of said inner race in which the ball bearings are adapted to roll, said outer race being also generally cylindrical and having a groove defined on its inner cylindrical surface in which said ball bearings are adapted to roll, the configuration and dimensions of the components being such that when the bearing is assembled, the ball bearings are prevented from escaping from the bearing or moving axially therein by virtue of the grooves in the races, and the ball bearings are prevented from moving circumferentially relative to one another by means of the cage, said inner race being further provided with a flange extending radially outwardly from its rearmost edge such that the base annulus of the cage is prevented from escaping axially rearwardly of the bearing, characterised in that the radial dimensions of the flange of the inner race, the base annulus of the cage and the rearmost lip defined on the interior surface of the outer race are such that an appreciable uninterrupted annular gap prevails between the rearmost lip on the inner surface of the outer race and one or other of the outer edges of the base annulus and the inner race flange.

18. Apparatus for dispensing a fluid to a bearing of which the apparatus is a part from a first position to a second spaced position, said apparatus including at least one water nozzle through which the fluid passes, said water nozzle provided to rotate with respect to the bearing.
